(19) United States
(12) Patent Application Publication
(10) Pub. No.: US 2014/0247701 A1
(43) Pub. Date: Sep. 4, 2014

(54) Electronic Timepiece

(71) Applicant: Seiko Epson Corporation, Tokyo (JP)

(72) Inventor: Katsuyuki Honda, Nagano-ken (JP)

(73) Assignee: Seiko Epson Corporation, Tokyo (JP)

(21) Appl. No.: 14/191,794

(22) Filed: Feb. 27, 2014

Related U.S. Application Data
(60) Provisional application No. 61/771,303, filed on Mar. 1, 2013.

(30) Foreign Application Priority Data
Mar. 8, 2013 (JP) 2013-046269

(51) Int. Cl. G04R 20/02; G04G 19/00

(52) U.S. Cl. CPC G04R 20/02; G04G 19/00
USPC 368/47; 368/205

(57) ABSTRACT

An electronic timepiece includes a receiving device that receives a satellite signal transmitted from a positioning information satellite; a display device that displays a time; a time correction unit that acquires time information from the satellite signal received by the receiving device and corrects the time to be displayed on the display device; and a case that accommodates the receiving device, the display device and the time correction unit. Power consumption of the receiving device is 30 mW or less, and a volume of the case is 30,000 mm³ or less.

### BACKGROUND

1. Technical Field

The present invention relates to an electronic timepiece, and particularly to an electronic timepiece having a receiving unit of a satellite signal.

2. Related Art

An electronic timepiece has been known which performs positioning or time correction by receiving a satellite signal transmitted from a Global Positioning System (GPS) satellite (for example, refer to JP-A-2009-168620 (Patent Reference 1)).

Incidentally, in order to realize an electronic timepiece of a wristwatch type disclosed in Patent Reference 1, it is necessary to reduce a size of the electronic timepiece to a wearable size on an arm. If the size of the electronic timepiece is reduced, a size of a battery which can be internally installed inside a case thereof is also reduced.

In contrast, a receiving device (receiving module) which receives a satellite signal requires significantly high power as compared to power for driving a timepiece which measures the time and drives guiding hands. In particular, when acquiring positioning information of a current location, acquiring time zone information of the current location and automatically correcting the time to a local time, three or more positioning information satellites have to be captured to receive satellite signals, thereby increasing power consumption significantly.

Accordingly, it has been required to provide a portable electronic timepiece such as the wristwatch which can acquire the positioning information, can acquire the time zone information and can correct the time to the local time.

### SUMMARY

An advantage of some aspects of the invention is to provide a portable electronic timepiece which can acquire positional information and correct the time information to a local time.

An electronic timepiece according to an aspect of the invention includes a receiving unit that receives a satellite signal transmitted from a positioning information satellite; a time display unit that displays a time; a time correction unit that acquires time information from the satellite signal received by the receiving unit and corrects the time to be displayed on the time display unit; and a case that accommodates the receiving unit, the time display unit and the time correction unit. Power consumption of the receiving unit is 30 mW or less, and a volume of the case is 30,000 mm³ or less.

According to the aspect of the invention, the power consumption of the receiving unit which receives the satellite signal transmitted from the positioning information satellite is restricted to 30 mW or less per hour. Therefore, it is possible to reduce a capacity or a size of batteries as compared to a case of using the receiving unit whose power consumption is larger than 30 mW.

Accordingly, it is possible to use the case whose volume is 30,000 mm³ or less. For this reason, the electronic timepiece can be miniaturized, and thus can be commercialized as a wristwatch which can correct the time information to a local time by acquiring positioning information. In addition, since the power consumption of the receiving unit is adapted to be low, the batteries can last for a longer duration. Therefore, it is possible to ensure the required duration for the wristwatch which can correct the time information to the local time by acquiring the positioning information.

The power consumption of the receiving unit is at the peak power consumption when searching for the positioning information satellite or when tracking the satellite after capturing the satellite. In the receiving unit of the aspect of the invention, since a state of the receiving unit is controlled during the searching or during the tracking, the peak power consumption is restricted to 30 mW or less.

It is preferable that the power consumption of the receiving unit is at the maximum power consumption when searching for the positioning information satellite without using orbit information of the positioning information satellite.

According to this configuration, the power consumption of the receiving unit is further minimized, thereby enabling the batteries to last for a longer duration. Therefore, it is possible to ensure the required duration for the wristwatch which can correct the time information to the local time by acquiring the positioning information.

It is preferable that the electronic timepiece includes a light-transmitting dial; a solar panel that is arranged in a rear surface side of the dial; and a secondary battery that is charged by power generated in the solar panel.

According to this configuration, since the secondary battery is charged by the solar panel, it is possible to eliminate a need for the charging by means of the external battery charger. Since the electronic timepiece can be portably charged while in use, it is possible to improve convenience. In addition, since it is possible to eliminate a need for battery replacement, it is possible to easily maintain waterproofing of the electronic timepiece.

An electronic timepiece according to another aspect of the invention includes a receiving unit that receives a satellite signal transmitted from a positioning information satellite; a light-transmitting dial; a solar panel that is arranged in a rear surface side of the dial; and a secondary battery that is charged by power generated in the solar panel. Power consumption of the receiving unit is 30 mW or less, and an area of a light receiving unit of the solar panel is 700 mm² or less.

According to the aspect of the invention, the power consumption of the receiving unit which receives the satellite signal transmitted from the positioning information satellite is restricted to 30 mW or less per hour. Therefore, it is possible to reduce a capacity or a size of secondary batteries as compared to a case of using the receiving unit whose power consumption is larger than 30 mW.

Accordingly, as the solar panel which charges the secondary battery, it is possible to use the solar panel in which the area of the light receiving unit is 700 mm² or less. For example, if the solar panel has a disk shape, it is possible to use the solar panel whose diameter is 30 mm or less.

For this reason, the electronic timepiece can be miniaturized, and thus can be commercialized as a wristwatch which can correct the time information to the local time by acquiring the positioning information. The power consumption of the receiving unit is minimized, thereby enabling the batteries to last for a longer duration. Therefore, it is possible to ensure the required duration for the wristwatch which can correct the time information to the local time by acquiring the positioning information.

Furthermore, since the secondary battery is charged by the solar panel, it is possible to eliminate the need for the charging by means of the external battery charger. Since the electronic timepiece can be portably charged while in use, it is possible to improve the convenience. In addition, since it is possible to eliminate the need for battery replacement, it is possible to easily maintain the waterproofing of the electronic timepiece.

An electronic timepiece according to still another aspect of the invention includes a receiving unit that receives a satellite signal transmitted from a positioning information satellite; a light-transmitting dial; a solar panel that is arranged in a rear surface side of the dial; and a secondary battery that is charged by power generated in the solar panel. Power consumption of the receiving unit is 30 mW or less, and a volume of the secondary battery is 600 mm³ or less.

According to the aspect of the invention, the power consumption of the receiving unit which receives the satellite signal transmitted from the positioning information satellite is restricted to 30 mW or less per hour. Therefore, it is possible to reduce the capacity or the size of secondary batteries as compared to a case of using the receiving unit whose power consumption is larger than 30 mW.

Accordingly, as the secondary battery, it is possible to use a secondary battery in which the size (volume) is 600 mm³ or less. That is, the size of the secondary battery can be restricted to a size which is comparable to a button type or a coin type battery.

For this reason, the electronic timepiece can be miniaturized, and thus can be commercialized as a wristwatch which can correct the time information to the local time by acquiring the positioning information. In addition, the power consumption of the receiving unit is minimized, thereby enabling the batteries to have the longer duration. Therefore, it is possible to ensure the required duration for the wristwatch which can correct the time information to the local time by acquiring the positioning information.

Furthermore, since the secondary battery is charged by the solar panel, it is possible to eliminate the need for the charging by means of the external battery charger. Since the electronic timepiece can be portably charged while in use, it is possible to improve the convenience. In addition, since it is possible to eliminate the need for battery replacement, it is possible to easily maintain the waterproofing of the electronic timepiece.

It is preferable that transmittance of the dial is from 50% to 70%.

The transmittance of the dial is affected by design elements such as abbreviations (indexes) and printing which are disposed on the dial. That is, if the abbreviations are removed, the transmittance can be improved. However, it is not possible to freely design the dial, thereby causing the design to be degraded. In contrast, it is possible to improve flexibility in the design of the dial by restricting the transmittance to 70% or less, thereby enabling the design to be improved.

In addition, if the transmittance is decreased to less than 50%, the power generation is also decreased in the solar panel. Therefore, in order to obtain the power generation (for example, 25 mW or more) corresponding to the power consumption of the receiving unit, it is necessary to increase the size of the solar panel, and thus the solar panel cannot be fitted to the size of the wristwatch.

In contrast, it the transmittance is 50% or more, the size of the solar panel can be restricted to a size which enables the solar panel to be incorporated into the wristwatch.

It is preferable that the receiving unit is configured to be capable of performing a receiving process in a positioning mode for acquiring positioning information and a receiving process in a timing mode for acquiring time information. It is preferable that the secondary battery is a lithium ion secondary battery and has a battery capacity whose duration is six months or longer in a fully charged state, when continuously driving the time display unit and performing the receiving process in the positioning mode once a day.

According to this configuration, the lithium ion secondary battery is used as the secondary battery. Thus, as compared to the secondary battery such as a nickel-hydrogen battery, energy density is high, thereby enabling the secondary battery to be miniaturized. Therefore, since the secondary battery can be incorporated into the electronic timepiece having the size of the wristwatch, it is possible to reliably drive the receiving unit requiring large power consumption.

In addition, even if the positioning mode for acquiring the positioning information is performed once a day, the secondary battery is provided with the battery capacity which enables the duration to be maintained for six months or longer. Thus, it is possible to ensure an opportunity for charging of the secondary battery by using the solar panel in the meantime. Therefore, it is possible to continuously use the electronic timepiece, thereby improving the convenience.

### BRIEF DESCRIPTION OF THE DRAWINGS

The invention will be described with reference to the accompanying drawings, wherein like numbers reference like elements.

FIG. 1 is a front view illustrating an electronic timepiece according to the invention.

FIG. 2 is a schematic cross-sectional view of an electronic timepiece.

FIG. 3 is a block diagram illustrating a configuration of an electronic timepiece.

FIG. 4 is a block diagram illustrating a configuration of a storage device.

FIG. 5 is a graph for describing a relationship between power consumption of a receiving device and a size of a case.

FIG. 6 is a flowchart illustrating a receiving process in an electronic timepiece.

FIG. 7 is a flowchart illustrating a receiving process in a positioning mode.

FIG. 8 is a graph for describing a relationship between power generation and a size of a solar cell.

FIG. 9 is a graph for describing a relationship between average power consumption and operating hours of a receiving device.

FIG. 10 is a graph for describing a relationship between duration of an electronic timepiece and a size of a battery.

### DESCRIPTION OF EXEMPLARY EMBODIMENTS

Hereinafter, specific embodiments of the invention will be described with reference to the drawings.

### First Embodiment

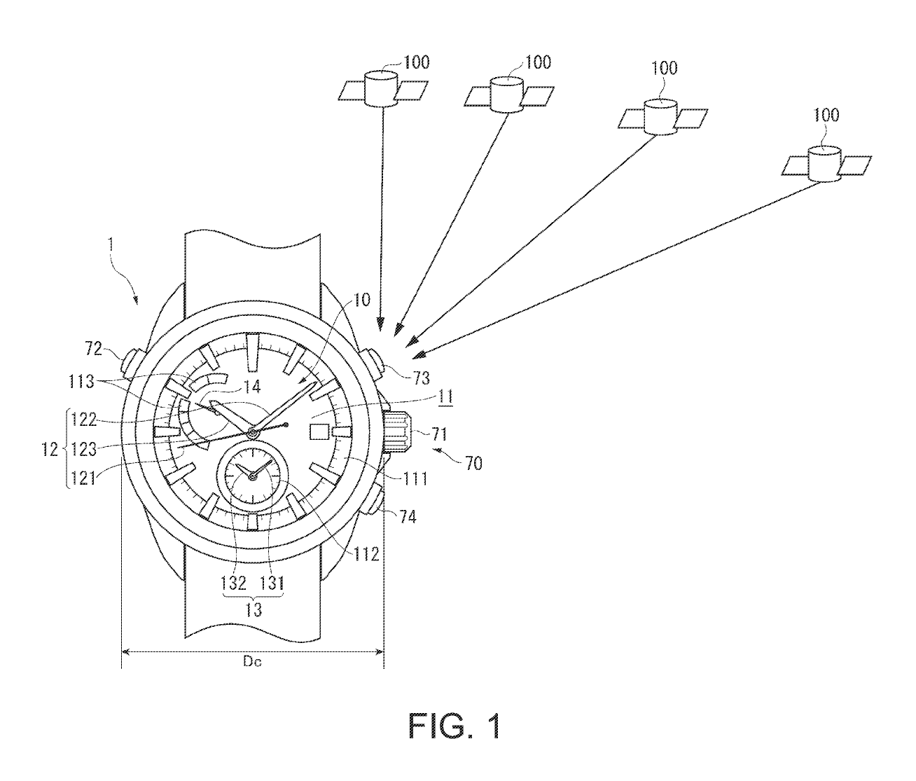

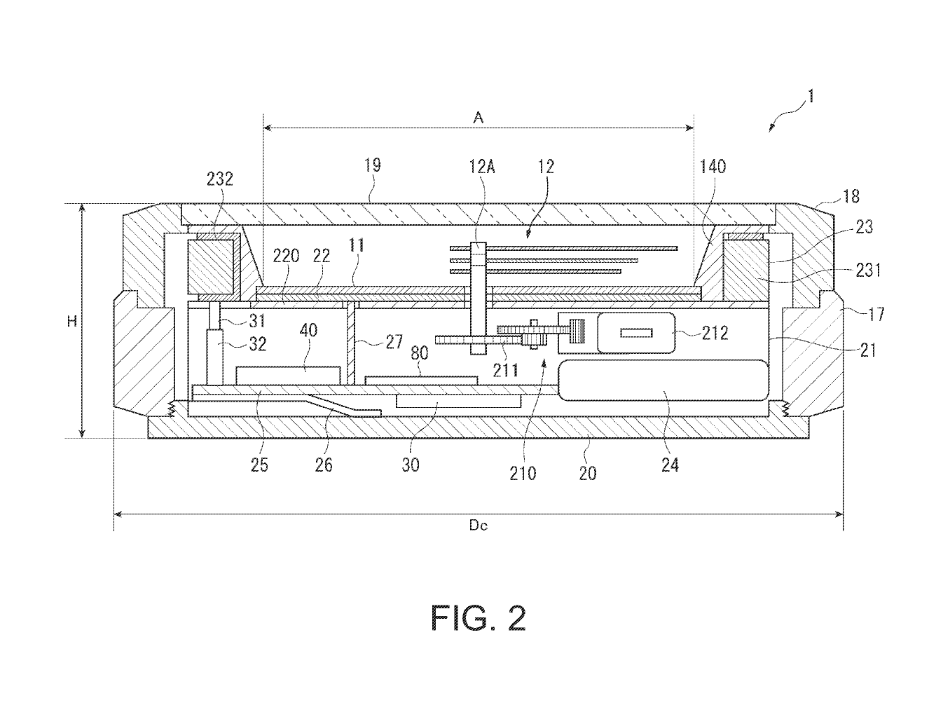

FIG. 1 is a front view illustrating an electronic timepiece 1 according to a first embodiment of the invention. FIG. 2 is a schematic cross-sectional view of the electronic timepiece 1.

As illustrated in FIG. 1, the electronic timepiece 1 receives a satellite signal from at least one GPS satellite 100 out of multiple GPS satellites 100 orbiting the earth in a predetermined orbit in the sky and acquires time information. The electronic timepiece is configured to calculate positioning information by receiving the satellite signal from at least three GPS satellites 100. The GPS satellite 100 is an example of a positioning information satellite, and multiple GPS satellites 100 are present in the sky over the earth. Approximately 30 GPS satellites 100 are currently orbiting the earth.

### Electronic Timepiece

The electronic timepiece 1 is a wristwatch which a user wears on the user's wrist, and includes a display device 10 (time display unit) that displays time or the like and an input device 70.

### Display Device

The display device 10 includes a dial 11, first guiding hands 12, second guiding hands 13 and an indicator hand 14.

The dial 11 is mostly formed of nonmetallic materials to which light and microwave of 1.5 GHz band are likely to be transmitted (for example, plastic or glass).

The dial 11 includes a main dial 111 corresponding to the first guiding hands 12, a sub-dial 112 corresponding to the second guiding hands 13, and a scale 113 corresponding to the indicator hand 14.

The first guiding hands 12 are disposed on a surface side of the main dial 111. The first guiding hands 12 include a second hand 121, a minute hand 122 and an hour hand 123. The first guiding hands 12 and the main dial 111 configure a first time display unit 110 (basic timepiece) which displays a first time.

The second guiding hands 13 are disposed on a surface side of the sub-dial 112. The second guiding hands 13 include a minute hand 131 and an hour hand 132. The second guiding hands 13 and the sub-dial 112 configure a second time display unit 120 (minor timepiece) which displays a second time.

Accordingly, the electronic timepiece 1 of the present embodiment includes a dual time function which can display the first time and the second time. The second time display unit 120 is set to have a display area smaller than that of the first time display unit 110.

In addition, the indicator hand 14 is disposed on the surface side of the main dial 111, and indicates various information items such as a remaining energy level (battery level).

Although not illustrated, the electronic timepiece 1 includes hand position detection means which detects a hand position of the first guiding hands 12. The hand position detection means includes a light sensor having a light emitting element and a light receiving element and a through hole disposed in a train wheel (gear) of each guiding hand. Known hand position detection means may be used which is configured so that the light receiving element can receive light transmitted from the light emitting element when the respective guiding hands are aligned in the 12 o'clock position. However, in the electronic timepiece 1, the hand position detection means of the second guiding hands 13 is not prepared.

The guiding hands 12 and 13 and the indicator hand 14 are driven by a step motor via gears. In the present embodiment, there are provided a step motor for driving the minute hand 122 and the hour hand 123 of the first guiding hands 12, a step motor for driving the second hand 121, a step motor for driving the indicator hand 14, and a step motor for driving the second guiding hands 13 (minute hand 131, hour hand 132). Furthermore, it is preferable to dispose a step motor for driving a date indicator when the date indicator is provided.

### Input Device

The input device 70 includes a crown 71 and three buttons 72, 73 and 74. If the input device 70 is operated, a process is executed according to the manual operation.

Specifically, if the crown 71 is shifted down by one stage, the second guiding hands 13 can be manually corrected. In this state, if the buttons 73 and 74 are pressed, the second guiding hands 13 are moved.

In addition, if the crown 71 is shifted down by two stages, the first guiding hands 12 can be manually corrected. In this state, if the buttons 73 and 74 are pressed, the first guiding hands 12 are moved.

If the button 72 is pressed, a process such as cancellation of various operation modes and a stop of a receiving process is executed according to a situation.

If the button 73 is pressed for a first setting period of time (for example, three seconds or longer, shorter than six seconds), a manual receiving process (compulsory receiving process) is executed in a timing mode. In addition, if the button 73 is pressed for a second setting period of time (for example, six seconds or longer) which is longer than the first setting period of time, a manual receiving process (compulsory receiving process) is executed in a positioning mode. Furthermore, if the button 73 is pressed for a period of time shorter than the first setting period of time (for example, shorter than three seconds), a result display process for displaying a result of the previous receiving process is performed.

If the button 74 is pressed, a process is executed in which setting of the time zone is indicated by the second hand 121.

The processes executed when the respective buttons 72, 73 and 74 are pressed are not limited to the above description, but may be appropriately set according to functions of the electronic timepiece 1.

### Structure of Electronic Timepiece

As illustrated in FIG. 2, the electronic timepiece 1 includes an outer case 17 made of a metal such as stainless steel (SUS) or titanium. The outer case 17 is formed in a substantially cylindrical shape. A surface glass 19 for covering an opening is attached to the opening of a surface side of the outer case 17 via a bezel 18. The bezel 18 is made of a non-metallic material such as ceramic so as to improve a receiving performance for satellite signals. A case back 20 is attached to an opening of a rear surface side of the outer case 17. The dial 11, a movement 21, a solar panel 22, a GPS antenna 23, and secondary battery 24 are arranged inside the outer case 17.

When a user wears the electronic timepiece on the user's wrist, a side of the electronic timepiece 1 which is worn on the wrist is referred to as a “rear surface side” and an opposite side (side where the guiding hands are visible) is referred to as a “surface side”.

The movement 21 includes a drive mechanism 210 which drives the display device 10 of the first guiding hands 12, the second guiding hands 13 and the indicator hand 14. The drive mechanism 210 is configured to include step motors, a train wheel 211 and a drive circuit which drives the step motors. The step motor is configured to have a motor coil 212, a stator and a rotor, and drives the first guiding hands 12 via the train wheel 211 or a rotation axle 12A.

A circuit board 25 is arranged in the case back 20 side of the movement 21.

A receiving device 30 which processes the satellite signal received by the GPS antenna 23, a control device 40 which performs various controls such as drive controls for the receiving device 30 or the step motors, a charging circuit 80 which charges power generated by the solar panel 22 to the secondary battery 24 are attached to the circuit board 25. The receiving device 30 and the control device 40 are driven by the power supplied from the secondary battery 24.

### Solar Panel

The solar panel 22 is a photovoltaic power generation element which performs photovoltaic power generation for converting light energy into electrical energy. The solar panel 22 includes seven to eight solar cells (not illustrated), and outputs the energy by connecting the solar cells in series.

As illustrated in FIG. 2, the solar panel 22 is supported by a solar panel support substrate 220. For example, the solar panel support substrate 220 is a conductive substrate having a thickness of 0.1 mm, for example, which is formed of a metallic material such as brass (BS), stainless steel (SUS) and titanium alloy. In this manner, the solar panel support substrate 220 functions as a part of the GPS antenna 23 after having a current distribution which is the same as that of the GPS antenna 23 arranged in close proximity.

The solar panel support substrate 220 is incorporated into the outer case 17 so as not to be in contact therewith. That is, the solar panel support substrate 220 is arranged so that an outer peripheral edge thereof is apart from and is not in contact with an inner peripheral surface of the outer case 17.

The dial 11 and the solar panel 22 are formed so that each outer diameter matches an inner diameter of dial ring 140 and each outer periphery is hidden by the dial ring 140. Accordingly, the solar panel support substrate 220 is not visible from outside. In addition, an outer dimension of the solar panel support substrate 220 is adapted to be larger than the solar panel 22 and the dial 11, and is enlarged to a lower surface position of the GPS antenna 23.

### GPS Antenna

The GPS antenna 23 includes an annular dielectric substrate 231 having a rectangular cross-sectional shape, and is a ring antenna, a surface of which has an antenna electrode 232.

The dielectric substrate 231 is adapted to shorten a wavelength of radio waves and, for example, can be configured to have so-called micarex (∈r=6.5 to 9.5), glass (∈r=5.4 to 9.9) and diamond (∈r=5.68) which are ceramics mainly composed of alumina (∈r=8.5) or ceramics mainly composed of mica.

The antenna electrode 232 is formed linearly and integrally with the dielectric substrate 231 by printing conductive metallic elements such as copper or silver on a surface of the dielectric substrate 231, or by bonding a conductive metallic plate such as silver or copper to the surface of the dielectric substrate 231. The antenna electrode 232 may be formed by forming patterns on the surface of the dielectric substrate 231 by means of electroless plating.

A connection pin 31 is in contact with the antenna electrode 232. The connection pin 31 is inserted to a connection base portion 32 having a substantially cylindrical shape. The connection base portion 32 is erected by being connected to a printed circuit on the circuit board 25.

The connection pin 31 and the connection base portion 32 are electrically connected to the receiving device 30 via the printed circuit. In the connection base portion 32, a biasing member such as a coil spring, for example, is disposed in an inner cylindrical portion thereof, and biases the connection pin 31 inserted to the connection base portion 32 against the antenna electrode 232 side. This causes the connection pin 31 to be pressed against a feeding point of the antenna electrode 232. In this manner, even when impact is applied to the electronic timepiece 1 for example, a connection state between the connection pin 31 and the antenna electrode 232 is maintained.

In the present embodiment, the case back 20 made of the conductive material also serves as a ground plate (reflection plate) of the GPS antenna 23. The case back 20 is electrically connected to a ground terminal 26 disposed in the movement 21. The ground terminal 26 is connected to a ground potential of the receiving device 30 of the movement 21. Therefore, the case back 20 is electrically connected to the ground potential of the receiving device 30 via the ground terminal 26, and functions as the ground plate (reflection plate) which reflects the radio waves incident from the surface glass 19 side toward the GPS antenna 23. Since the outer case 17 which has the conductive material and is in contact with the case back 20 is the ground potential, the outer case 17 also functions as the ground plate.

Furthermore, the case back 20 and the outer case 17 are made of the metal. Accordingly, in addition to the function as the ground plate, it is possible to avoid influence on the GPS antenna 23 when the user wears the electronic timepiece 1 on the arm. That is, if the case is a plastic case, a resonance frequency of the GPS antenna 23 is changed by receiving the influence from the neighboring arm between a wearing state and a non-wearing state. Thus, it is not preferable since there is a difference in performance. However, since the case is made of the metal, it is possible to avoid the influence from the arm by virtue of the shield effect. In the present embodiment, there is little difference in antenna characteristics between the wearing state and the non-wearing state, thereby allowing a stable receiving performance.

### Secondary Battery

The secondary battery 24 is a power supply device of the electronic timepiece 1, and stores power generated by the solar panel 22.

In the electronic timepiece 1, two electrodes of the solar panel 22 and two electrodes of the secondary battery 24 can be respectively and electrically connected to each other by two conductive coil springs 27. When connected, the secondary battery 24 is charged by the photovoltaic power generation of the solar panel 22. In the present embodiment, a lithium ion secondary battery suitable for portable devices is used as the secondary battery 24. However, a lithium polymer battery or other secondary batteries may be used, and alternatively a rechargeable battery different from the secondary battery (for example, capacitance elements) may be used.

### Circuit Configuration of Electronic Timepiece

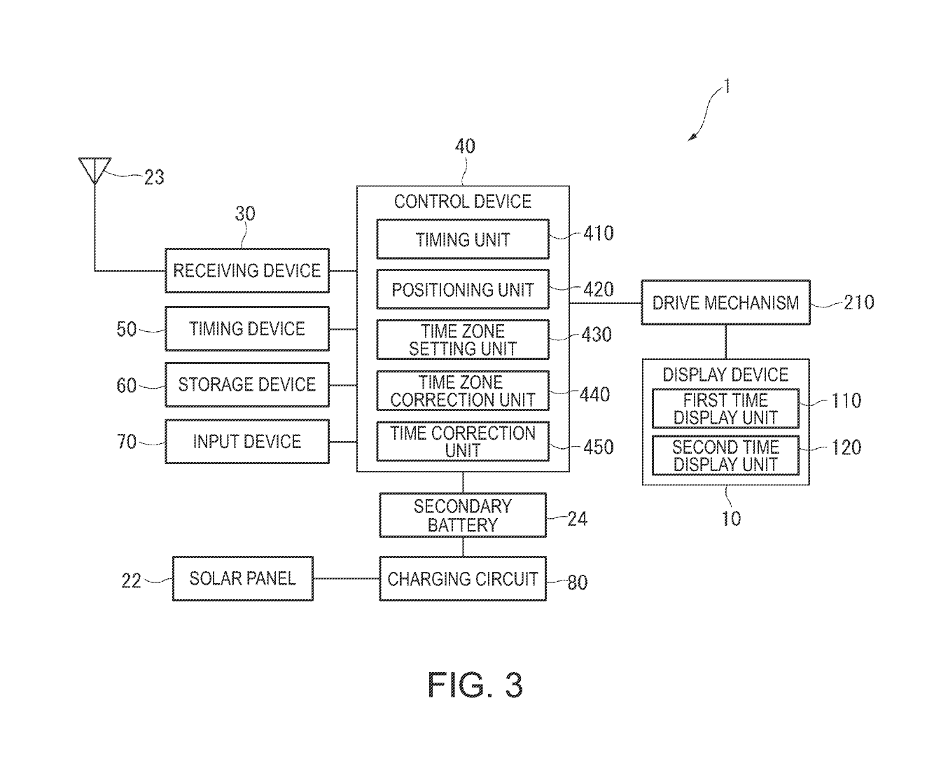

FIG. 3 is a block diagram illustrating a circuit configuration of the electronic timepiece 1. The electronic timepiece 1 includes the receiving device 30 (receiving unit), the control device 40 (control unit), a timing device 50 (timing unit), the storage device 60 (storage unit) and the input device 70 (operation unit).

### Receiving Device

The receiving device 30 which is a receiving module (GPS module) is a load driven by the power stored in the secondary battery 24, and when driven by the control device 40, receives the satellite signal transmitted from the GPS satellite 100 through the GPS antenna 23. Then, when successfully receiving the satellite signal, the receiving device 30 transmits the acquired information such as orbit information and GPS time information to the control device 40. In contrast, when failing to receive the satellite signal, the receiving device 30 transmits information indicating the failure to the control device 40. A configuration of the receiving device 30 is the same as a configuration of a known GPS receiving circuit. Therefore, description thereof will be omitted.

### Timing Device

The timing device 50 includes a quartz crystal resonator driven by the power stored in the secondary battery 24, and updates time data by using a reference signal based on a vibration signal of the quartz crystal resonator.

### Storage Device

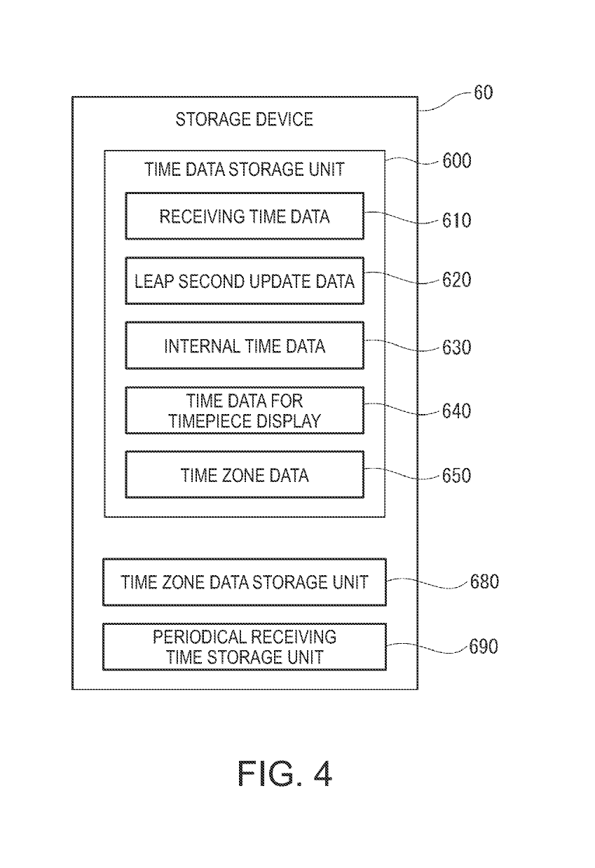

As illustrated in FIG. 4, the storage device 60 includes a time data storage unit 600, a time zone data storage unit 680 and a periodical receiving time storage unit 690.

The time data storage unit 600 stores receiving time data 610, leap second update data 620, internal time data 630, time data for timepiece display 640 and time zone data 650.

The receiving time data 610 stores time information (GPS time) acquired from the satellite signal. The receiving time data 610 is usually updated by the timing device 50 once for every second, and is corrected based on the acquired time information (GPS time) when receiving the satellite signal.

The leap second update data 620 stores at least current leap second data. That is, page 18 in a sub-frame 4 of the satellite signal includes each data item of “current leap second”, “update week of the leap second”, “update date of the leap second” and the “leap second after the update” as the data relating to the leap second. Among them, in the present embodiment, at least the “current leap second” data is stored in the leap second update data 620.

The internal time data 630 stores internal time information. The internal time information is updated by the GPS time stored in the receiving time data 610 and the “current leap second” stored in the leap second update data 620. That is, Coordinated Universal Time (UTC) is stored in the internal time data 630. When the receiving time data 610 is updated in the timing device 50, the internal time information is also updated.

The time data for timepiece display 640 stores time data where the time zone data (time zone information, time difference information) of the time zone data 650 is added to the internal time information of the internal time data 630. The time zone data 650 is set by the positioning information obtained when receiving the positioning information in a positioning mode.

The time zone data storage unit 680 associates the positioning information (latitude and longitude) with the time zone information (time difference information) and stores the information. Therefore, when acquiring the positioning information in the positioning mode, the control device 40 can acquire the time zone data based on the positioning information (latitude and longitude).

The time zone data storage unit 680 may store a city name and the time zone data in association with each other. In this case, if the user selects the city name where the user wants to know the local time by operating the input device 70, the control device 40 may search for the city name set by the user from the time zone data storage unit 680 and may acquire the time zone data corresponding to the city name so as to be set in the time zone data 650.

The periodical receiving time storage unit 690 stores periodical receiving time for executing a periodical receiving process in the timing unit 410. As the periodical receiving time, time which is successfully and compulsorily received by operating the button 73 is previously stored.

### Control Device

The control device 40 is configured to have a CPU for controlling the electronic timepiece 1. The control device 40 includes the timing unit 410, the positioning unit 420, the time zone setting unit 430, the time zone correction unit 440 and the time correction unit 450.

### Timing Unit

The timing unit 410 operates the receiving device 30 and performs the receiving process in a timing mode. In the present embodiment, the receiving process in the timing mode is performed between an automatic receiving process and a manual receiving process.

There are two types of automatic receiving processes, a periodical automatic receiving process and a light automatic receiving process. That is, when the timed internal time data 630 becomes periodical receiving time stored in the periodical receiving time storage unit 690, the timing unit 410 operates the receiving device 30 and performs the periodical automatic receiving process in the timing mode.

In addition, when it can be determined that a power generation voltage or power generation current of the solar panel 22 is equal to or higher than a setting value and sun light is emitted to the solar panel 22 outdoors, the timing unit 410 operates the receiving device 30 and performs the light automatic receiving process in the timing mode. The number of processes for operating the receiving device 30 in the power generation state of the solar panel 22 may be restricted to once a day.

Furthermore, when the user presses the button 73 of the input device 70 to perform the compulsory receiving operation, the timing unit 410 operates the receiving device 30 and performs the manual receiving process in the timing mode.

The timing unit 410 causes the receiving device 30 to capture at least one GPS satellite 100 and acquires the time information by receiving the satellite signal transmitted from the GPS satellite 100.

### Positioning Unit

The positioning unit 420, when the user presses the button 73 of the input device 70 to perform the compulsory receiving operation, operates the receiving device 30 and performs the receiving process in the positioning mode.

According to the period of time while the button 73 is pressed, the control device 40 performs a process by switching between the receiving process in the timing mode using the timing unit 410 and the receiving process in the positioning mode using the positioning unit 420. That is, the control device 40 performs the receiving process in the timing mode when the button 73 is pressed for the first setting period of time (three seconds or longer, shorter than six seconds), and performs the receiving process in the positioning mode when the button 73 is pressed for the second setting period of time (six seconds or longer).

If the receiving process in the positioning mode is started, the positioning unit 420 captures at least three GPS satellites 100 (preferably four or more) by the receiving device 30, receives the satellite signal transmitted from each GPS satellite 100, and acquires the positioning information by means of calculation. In addition, when receiving the satellite signal, the positioning unit 420 can also simultaneously acquire the time information.

### Time Zone Setting Unit

When the positioning unit 420 successfully acquires the positioning information, the time zone setting unit 430 acquires the time zone data (time zone information, that is, time difference information) from the time zone data storage unit 680 based on the acquired positioning information (latitude and longitude), and is stored in the time zone data 650.

For example, since Japan Standard Time (JST) is nine hours ahead of UTC (UTC+9), when the positioning information acquired by the positioning unit 420 is in Japan, the time zone setting unit 430 reads out the time difference information (plus nine hours) of Japan Standard Time from the time zone data storage unit 680 and stores the time difference information in the time zone data 650.

### Time Zone Correction Unit

When the time zone setting unit 430 sets the time zone information, the time zone correction unit 440 corrects the first time, that is, the time data for timepiece display 640 by using the time zone data. Therefore, the time data for timepiece display 640 is the time in which the time zone data is added to the internal time data 630 which is UTC.

In contrast, the time zone correction unit 440 does not correct the second time by using the time zone information.

### Time Correction Unit

When the time information is successfully acquired by the receiving process of the timing unit 410 or the receiving process of the positioning unit 420, the time correction unit 450 corrects the receiving time data 610 by the acquired time information. Therefore, the internal time data 630 and the time data for timepiece display 640 are also corrected. If the time data for timepiece display 640 is corrected, guiding time of the first guiding hands 12 which is synchronized with the time data for timepiece display 640 by hand position detection means is also corrected.

### Size of Electronic Timepiece

The case of the electronic timepiece 1 is configured to have the outer case 17, the bezel 18, the surface glass 19 and the case back 20. The case is formed to have a volume of 30,000 mm³ or less. The outer case 17 of the present embodiment is formed in a substantially cylindrical shape. For example, if a diameter D_{C} of the case is 47 mm and a height dimension H is 16.5 mm, the volume is (47/2)²×π×16.5=approximately 28,627 mm³, and the volume is 30,000 mm³ or less.

In this case, the diameter D_{C} of the case is a diameter of the outer case 17. Specifically, a straight line which passes through a center (rotation axle 12A) of the dial 11 and is in parallel with the case back is referred to as a distance between two points intersected with an outer periphery of the outer case. The distance may be a distance in a direction between three o'clock and nine o'clock of the dial 11, for example. However, the distance does not include a portion having a convex shape due to the crown or the like, and is a distance in a case where the shape of the outer case 17 is approximated to a circle when the electronic timepiece 1 is viewed in a plan view. When the diameter of the bezel 18 is larger than the diameter of the outer case 17, the diameter D_{C} of the case may be set to be the diameter of the bezel 18. In short, the diameter D_{C} is the distance which is generally referred to as the size of the wristwatch.

The height dimension H is the distance from the surface of the surface glass 19 to the rear surface of the case back 20. Depending on the design of the electronic timepiece 1, it is considered as a case where a central portion of the surface glass 19 is inflated or a case where the bezel 18 is higher than the surface glass 19 (distance from the case back is longer). In these cases, it is preferable to measure the distance between a position farthest away from the case back 20 and the case back 20. In short, the height dimension H is the distance which is generally referred to as the thickness of the wristwatch.

If the volume of the case of the electronic timepiece 1 becomes larger than 30,000 mm³, the size of the outer case becomes large, thereby causing difficulty in commercializing the wristwatch.

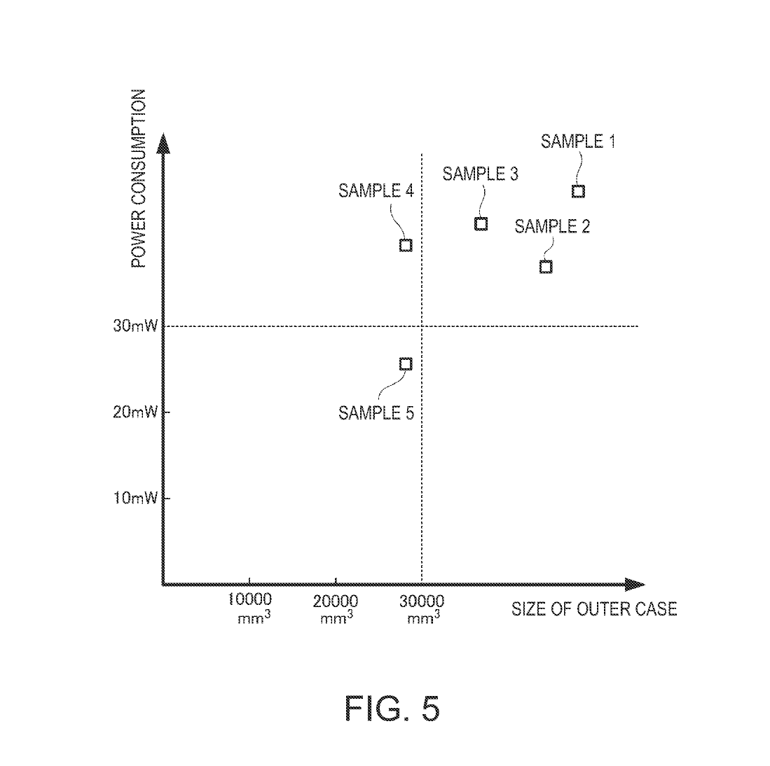

For example, the receiving device (GPS module) in the related art requires power consumption of larger than 30 mW. Accordingly, a replaceable battery which can be attached to or detached from the case is used as a power source. Therefore, the size of the battery becomes large and as illustrated by samples 1 to 3 in FIG. 5, the case which internally has the battery also requires the size (volume) which is equal to or larger than 30,000 mm³. Thus, it is not possible to miniaturize the size of the general wristwatch.

In addition, in recent years, a volumetric energy density becomes higher and the lithium ion secondary battery is used. In this regard, as illustrated by a sample 4 in FIG. 5, a technology has been developed which can decrease the size of the case as compared to the case in the related art.

However, since it is necessary to perform external charging by connecting the secondary battery to the battery charger, it is not possible to portably charge the secondary battery. Furthermore, since the power consumption of the receiving device is large, the duration of the battery is shortened, thereby increasing the number of times for charging. Therefore, the convenience is degraded when being used as the wristwatch.

On the other hand, in the present embodiment, as illustrated by a sample 5, the power consumption of the receiving device 30 is decreased to 30 mW or less (for example, 25 mW).

The electronic timepiece of the wristwatch type has a restriction on the capacity of the storage device 60 which can be internally provided therein. Thus, it is difficult to store satellite orbit information of the GPS satellite 100 (almanac or ephemeris). Therefore, since searching for the satellite is performed in a state where the satellite orbit information is not used (cold start), the power consumption is increased particularly when searching for the GPS satellite 100. Thus, in the present embodiment, by controlling a state of the receiving device 30 when searching for the GPS satellite 100, peak power consumption (maximum power consumption) is decreased during the searching in the cold start in the receiving device 30.

The power consumption of the receiving device 30 is not limited to the power consumption during the searching, and may be the power consumption during tracking. That is, when determining whether or not the power consumption of the receiving device 30 is 30 mW or less, the power consumption is not limited to a case where it is determined whether or not the power consumption during the searching is decreased to 30 mW or less. The power consumption may be determined by whether or not the power consumption during the tracking is decreased to 30 mW or less. Furthermore, the power consumption may be determined by the average power consumption during the searching and the tracking.

That is, in some cases, the power consumption of the GPS module which is the receiving device 30 is represented by not only the power consumption during the searching but also the power consumption during the tracking. The power consumption is also represented by the average power consumption during the searching and the tracking. When designing and manufacturing the electronic timepiece 1, it is necessary to use the receiving device 30 (GPS module) whose power consumption is 30 mW or less. However, in this case, it may be determined by published power consumption of the receiving device 30.

### Operation of Control Device

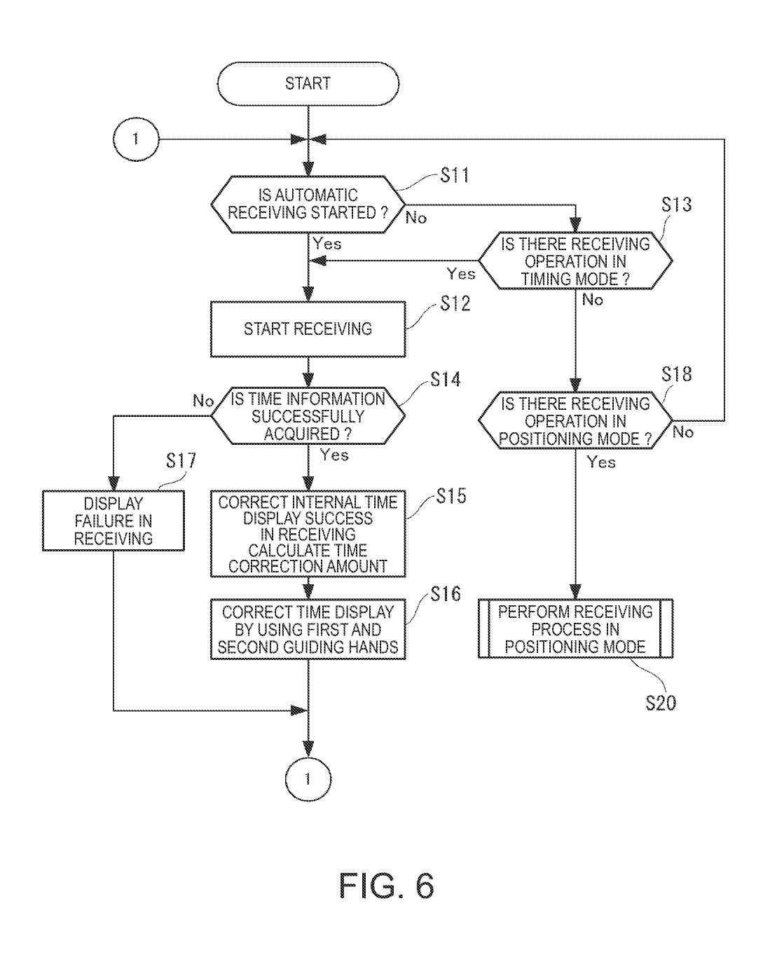

FIG. 6 is a flowchart illustrating the receiving process of the satellite signals of the electronic timepiece 1 according to the first embodiment.

If the receiving process is started, the control device 40 determines whether the process is relevant to a condition for starting the automatic receiving (S11). As described above, when it is the periodical receiving time and when the power generation voltage or current in the solar panel 22 is equal to or higher than the setting value, the control device 40 determines that the process is relevant to the condition for starting the automatic receiving (S11: YES).

When it is determined Yes in S11, the timing unit 410 starts the receiving process in the timing mode (S12).

When it is determined No in S11, the control device 40 determines whether or not there is the receiving operation in the timing mode where the button 74 is pressed for the first setting period of time (three seconds or longer, shorter than six seconds) (S13).

When it is determined Yes in S13, the timing unit 410 starts the receiving process in the timing mode (S12).

### Receiving Process in Timing Mode

If the receiving process in the timing mode is started in S12, the timing unit 410 determines whether or not the time information is successfully acquired (S14).

The receiving device 30 first performs searching to capture the GPS satellite 100. If the GPS satellite 100 is captured, the receiving device 30 receives the satellite signal and acquires the time information. Since the time information is transmitted at intervals of six seconds, the time information can be received by receiving the satellite signal for six seconds. when the time information can be acquired, the control device 40 determines Yes in S14. In other cases, that is, in a case where the receiving device 30 cannot capture the GPS satellite 100 or in a case where the time information cannot be received, the control device 40 determines that the acquisition of the time information fails (S14: No).

### Correction Process of Internal Time in Timing Mode

When it is determined that the time information is successfully acquired (S14: case of Yes), the control device 40 causes the time correction unit 450 to correct the receiving time data 610 by using the acquired time information, and the internal time data 630 is corrected by being further compensated in the leap second update data 620 (S15). If the internal time data 630 is corrected, the time data for timepiece display 640 is also corrected by the time zone data 650 which is set.

In addition, the control device 40 displays the success in the receiving by moving the second hand 121 to a predetermined position via the drive mechanism 210 (S15). The display of the success in the receiving is performed for a predetermined period of time, for example, five seconds.

Furthermore, the control device 40 calculates the time correction amount from the time difference before and after the internal time data 630 is corrected (S15).

Here, the second guiding hands 13 are operated in conjunction with the internal time data 630, that is, the first guiding hands 12. That is, if the time data of the internal time data 630 is changed by the reference signal from the timing device 50, the second guiding hands 13 in addition to the first guiding hands 12 are also operated in conjunction therewith. The second guiding hands 13 do not include the second hand and have only the minute hand 131 and the hour hand 132. Accordingly, the second guiding hands 13 are not operated every one second, but are operated every 20 seconds for example.

In the present embodiment, there is provided a hand position detection mechanism which detects a guiding hand position of the first guiding hands 12. In contrast, there is no hand position detection mechanism which detects a guiding hand position of the second guiding hands 13. Therefore, the time data (UTC) of the internal time data 630 is not coincident with the time which is actually guided by the second guiding hands 13. The second guiding hands 13 are operated by the time difference which is manually set. For example, when the internal time data 630 (UTC) is zero second, zero minute, one o'clock, it is assumed that the second guiding hands 13 are set to be zero second, zero minute, ten o'clock by the manual operation. In this case, it is assumed that the second guiding hands 13 are set to have the time difference of plus nine hours with respect to the internal time data 630 by the manual operation.

Thereafter, in conjunction with the receiving time data 610 and the internal time data 630 being updated by the reference signal from the timing device 50, the second guiding hands 13 are also operated.

In addition, if the timing unit 410 or the positioning unit 420 receives the time information, the receiving time data 610 is updated by the received time information and the internal time data 630 is also updated in conjunction therewith, and the second guiding hands 13 are also moved in conjunction therewith by the time correction amount of the internal time data 630.

For example, when the internal time data 630 (UTC) is 40 seconds, 25 minutes, three o'clock and the time guided by the second guiding hands 13 is 40 seconds, 25 minutes, 12 o'clock, it is assumed that the internal time data 630 is updated to zero second, 26 minutes, three o'clock by using the received time information. In this case, the time correction amount of the internal time data 630 is plus 20 seconds. Therefore, the second guiding hands 13 are also ahead by 20 seconds and guide zero second, 26 minutes, 12 o'clock.

Next, the time correction unit 450 of the control device 40 corrects the display time guided by the first guiding hands 12, based on the time data for timepiece display 640 (S16). In addition, the time correction unit 450 corrects the second guiding hands 13 according to the time correction amount (S16). That is, the first guiding hands 12 and the second guiding hands 13 are operated by the correction amount of the same internal time data 630, and thus are corrected in conjunction with each other.

When it is determined No in S14 (in a case where the receiving fails), the control device 40 does not perform the correction process (S15) of the internal time, moves the second hand 121 to a predetermined position via the drive mechanism 210, and displays that the receiving fails (S17). The display of the failure in the receiving is also performed for a predetermined period of time, for example, five seconds.

If the processes in S16 and S17 are completed, the control device 40 returns to the process in S11.

### Receiving Process in Positioning Mode

When it is determined No in S13, the control device 40 determines whether or not there is the receiving operation in the positioning mode where the button 74 is pressed for the second setting period of time (six seconds or longer) (S18).

When it is determined No in S18, the control device 40 returns to the process in S11.

In contrast, when it is determined Yes in S18, the positioning unit 420 executes the receiving process in the positioning mode (S20).

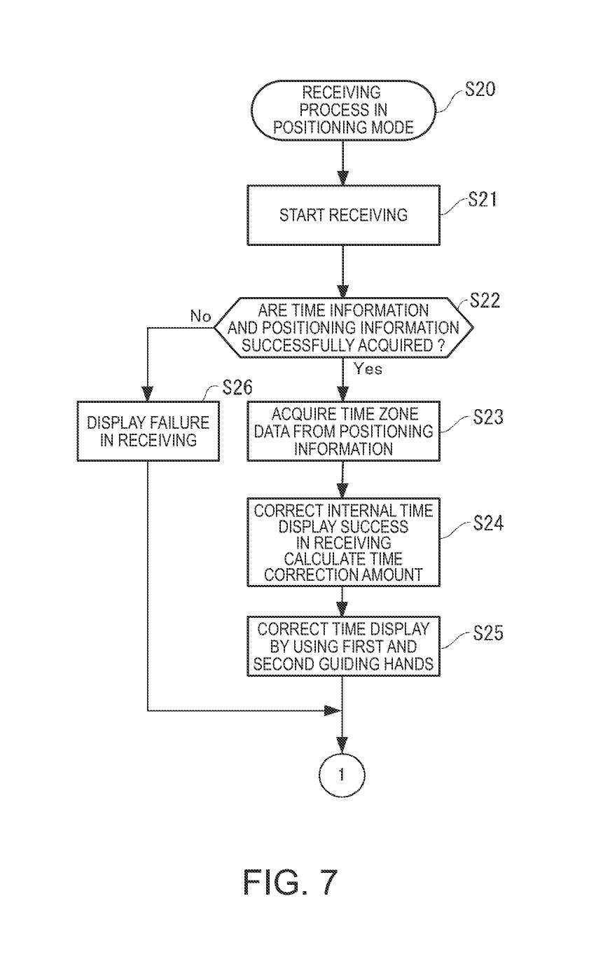

Next, the receiving process S20 in the positioning mode is illustrated in FIG. 7.

The positioning unit 420 first starts the receiving process in the positioning mode (S21).

After the receiving process is started in S21, the control device 40 determines whether or not the time information and the positioning information are successfully received (S22).

### Time Correction Process in Positioning Mode

When determining that the time information and the positioning information are successfully received by the receiving process (S22: case of Yes), the control device 40 acquires the time zone data corresponding to the acquired positioning information from the time zone data storage unit 680 and corrects the time zone data 650 (S23).

In addition, the control device 40 corrects the internal time data 630 by using the acquired time information and corrects the time data for timepiece display 640 in new time zone data 650. Furthermore, the control device 40 moves the second hand 121 to a predetermined position, displays that the receiving is successful, and performs calculation process of the time correction amount (S24). This display of the success in the receiving is also performed for a predetermined period of time, for example, five seconds.

Then, the time correction unit 450 corrects the time display guided by the first guiding hands 12 and the second guiding hands 13 in S25. At this time, the display time of only the first guiding hands 12 is corrected by the time zone data acquired from the positioning information in S23. The second guiding hands 13 are corrected by the time correction amount of the internal time data 630. In this manner, even when travelling to a country having the different time zone by plane or the like, it is possible to automatically correct the first guiding hands 12 to the local time.

For example, it is assumed that the user of the electronic timepiece 1 stays in New York, the time zone data is set to have the time difference with minus five hours of Eastern Standard Time of America (EST) and the second guiding hands 13 are set to be Japan Standard Time (JST).

Here, when the internal time data 630 (UTC) is 50 seconds, 25 minutes, six o'clock, the time guided by the first guiding hands 12 is 50 seconds, 25 minutes, one o'clock (EST), and the time guided by the second guiding hands 13 which are manually set is 50 seconds, 25 minutes, 15 o'clock (JST), it is assumed that the receiving process is performed in the positioning mode in Germany to which the user travels on a business trip.

As a result, it is assumed that the received time information allows the internal time data 630 (UTC) to be updated to be 55 seconds, 25 minutes, six o'clock and the time zone data obtained from the positioning information is set to have plus one hour (Central European Time: CET).

In this case, since the time correction amount of the internal time data 630 is plus five seconds, the second guiding hands 13 are also ahead by plus five seconds and guide 55 seconds, 25 minutes, 15 o'clock. In addition, since the time zone data is changed to have plus one hour, the time data for timepiece display 640 is 55 seconds, 25 minutes, seven o'clock, and the first guiding hands 12 also guide 55 seconds, 25 minutes, seven o'clock.

In contrast, when it is determined No in S22 (in a case where the receiving fails), the control device 40 moves the second hand 121 to a predetermined position via the drive mechanism 210 and displays that the receiving fails (S26). This display of the failure in the receiving is also performed for a predetermined period of time, for example, five seconds.

If the processes in S25 and S26 are completed, the control device 40 completes the receiving process S20 in the positioning mode, and returns to the process in S11 of FIG. 6. Therefore, until it is determined Yes in either S11, S13 or S18, the control device 40 maintains a standby state where the receiving process has not yet started.

### Advantageous Effect of First Embodiment

According to the present embodiment, the following advantageous effect can be obtained.

In the electronic timepiece 1, the power consumption of the receiving device 30 which receives the satellite signal transmitted from the GPS satellite 100 is restricted to 30 mW or less per hour. Therefore, it is possible to reduce the capacity or the size of the secondary battery 24 as compared to a case of using the receiving device whose power consumption is larger than 30 mW.

Accordingly, it is possible to use the outer case 17 whose capacity is 30,000 mm³ or less. Therefore, the electronic timepiece 1 can be miniaturized and thus, can be commercialized as a wristwatch which can acquire the positioning information and correct the time to the local time.

In addition, since the power consumption of the receiving device 30 is decreased, the longer duration of the secondary battery 24 can also be expected. Therefore, it is possible to ensure the required duration for the wristwatch which can acquire the positioning information and correct the time to the local time.

The power consumption of the receiving device 30 is set to be larger than at least zero (for example, 1 mW or more).

In the electronic timepiece 1, since the secondary battery 24 is charged by the solar panel 22, it is possible to eliminate the need for the charging by means of the external battery charger. Since the electronic timepiece 1 can be portably charged while in use, it is possible to improve the convenience. In addition, since it is possible to eliminate the need for a battery replacement, it is possible to easily maintain the waterproof of the electronic timepiece 1.

There are provided two time display units such as the first guiding hands 12 which are the first time display unit 110 and the second guiding hands 13 which are the second time display unit 120. Therefore, the first guiding hands 12 can display the local time and the second guiding hands 13 can display the home time.

Then, if the positioning unit 420 acquires the positioning information of the current location and the time zone setting unit 430 sets the time zone data 650 of the current location, the time zone correction unit 440 corrects the first time guided by the first guiding hands 12 by using the time zone data 650. Accordingly, when the user wearing the electronic timepiece 1 travels to a country having the different time zone by plane or the like, the positioning unit 420 acquires the positioning information. In this simple manner, the first guiding hands 12 can display the first time, that is, the local time of the current location.

In contrast, even when the time zone data 650 is set, the time zone correction unit 440 does not correct the second time guided by the second guiding hands 13. Therefore, the second guiding hands 13 can always display the home time.

Accordingly, the first guiding hands 12 can easily display the local time and the second guiding hands 13 can always display the home time set by the user. Therefore, even when moving abroad, it is possible to easily confirm the time of the user's hometown.

In addition, in this configuration, the receiving process is performed in the timing mode during the automatic receiving process and the receiving in the positioning mode where the receiving time is longer is executed only when the button 74 is pressed for the second setting period of time. In this manner, the receiving process of the positioning mode is executed only when the user of the electronic timepiece 1 intentionally performs the receiving operation. Therefore, without having to continue the receiving for a long period of time in a state where the satellite signal cannot be received, it is possible to prevent the power from being significantly consumed.

The case of the electronic timepiece 1 is configured to have the outer case 17, the bezel 18, the surface glass 19 and the case back 20. However, a configuration without using the bezel 18 or a configuration where the outer case 17 and the case back 20 are integrated with each other may be employed. In short, it is advantageous if the case internally accommodates configuring elements of the electronic timepiece 1, such as the dial 11, the movement 21, the solar panel 22, the GPS antenna 23 and the secondary battery 24.

### Second Embodiment

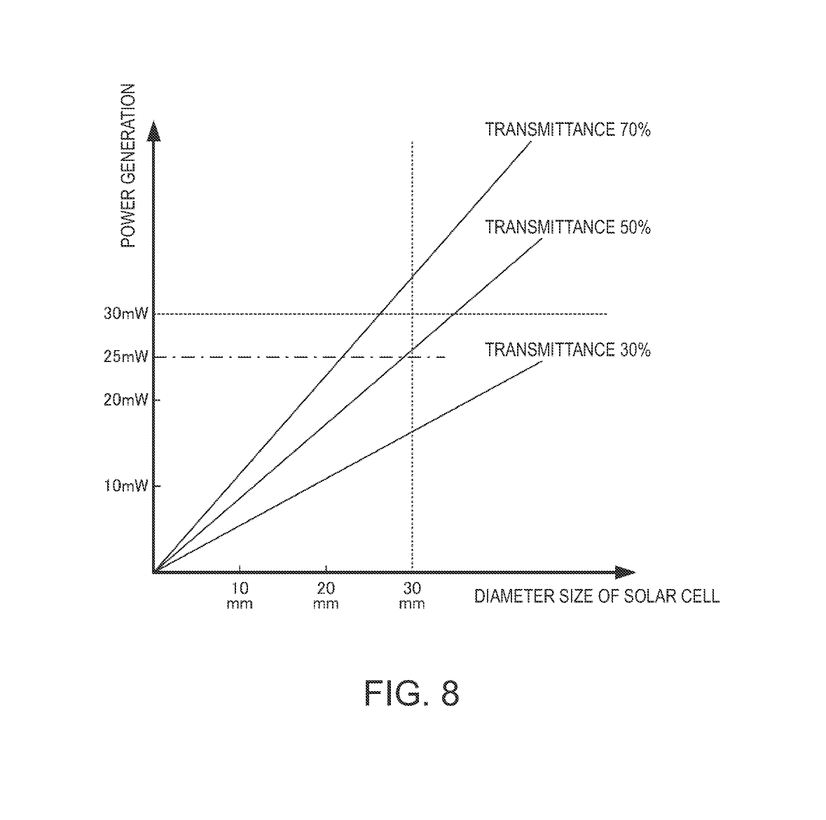

Next, a second embodiment of the invention will be described with reference to FIG. 8. The second embodiment is made by setting the power consumption of the receiving device 30, the size (power generation) of the solar panel 22 and the transmittance of the dial 11. Except for these, the structure and the control process of the electronic timepiece 1 is similar to those in the first embodiment, and thus description thereof will be omitted.

Similar to the first embodiment, the second embodiment employs the receiving device 30 whose power consumption is 30 mW or less. Furthermore, the size of the solar panel 22 (the same size as that of the dial 11) is set to be 30 mm or shorter in diameter so as to suppress the size of the dial 11 and the solar panel 22. That is, the area of the light receiving unit of the solar panel 22 is set to be approximately 700 mm² or less.

Specifically, the light receiving unit of the solar panel 22 is a portion on which the light passing through the dial 11 is directly incident, within the light receiving surface (surface of the dial 11 side) of the solar panel 22. For example, within the solar panel 22, the light receiving unit is a portion excluding the portion hidden by the dial ring 140. For example, the light receiving unit is a portion illustrated by A in FIG. 2. If the size (outer periphery) of the solar panel 22 is set to be 30 mm or shorter in diameter, the light receiving unit is a portion having a substantially circular shape of 28 mm in diameter. Since the area of the circle of 28 mm in diameter is approximately 615 mm², it is possible to satisfy the condition of approximately 700 mm² or less. In addition to the portion hidden by the dial ring 140, the light receiving unit may include a portion where the light is not incident on the solar panel 22 due to the design of the dial 11 and a portion excluding the date window portion for displaying the date.

This sets the wristwatch to have an appropriate size and enables commercialization.

At this time, it is necessary to cause the power generation of the solar panel 22 to be equal to or larger than the power consumption of the receiving device 30. Therefore, the size of the solar panel 22 is also set in view of the power generation.

For example, when the receiving device 30 whose power consumption is 25 mW is incorporated in the electronic timepiece 1, it is necessary to adjust the transmittance of the dial 11 and the size of the solar panel 22 in order to obtain the power generation of 25 mW or more.

The transmittance of the dial 11 is a ratio between an amount of the light incident on the surface of the solar panel 22 after passing through the surface glass 19 and the dial 11 when the light is emitted to the surface of the electronic timepiece 1 and an amount of the light incident on the surface of the electronic timepiece 1.

Therefore, the transmittance of the dial 11 mainly depends on the design of the electronic timepiece 1. That is, the transmittance of the dial 11 is affected by design elements which block the light, such as the printing and abbreviations (indexes) on the surface glass 19 and the dial 11. Therefore, the normal transmittance in the electronic timepiece 1 is 70% or less.

Here, as illustrated in FIG. 8, in order to obtain the power generation of 25 mW or more when the transmittance of the dial 11 is 70%, the diameter size of the solar panel 22 is set to be approximately 22 mm or longer.

In contrast, in order to obtain the power generation of 25 mW or more when the transmittance of the dial 11 is 50%, it is necessary to set the diameter size of the solar panel 22 to be approximately 28 mm or longer.

Furthermore, the transmittance of the dial 11 is decreased to 30%, the power generation of 25 mW or more cannot be obtained in the range where the diameter size of the solar panel 22 is 30 mm or shorter.

Therefore, in the present embodiment, the transmittance of the dial 11 is set to be from 50% to 70%.

Accordingly, when designing and manufacturing the electronic timepiece 1, in order to improve the convenience of portability as a wristwatch and chargeability by using the solar panel 22, the power consumption of the receiving device 30 is set to be 30 mW or less and the size of the solar panel 22 is set to be 30 mm or shorter. Furthermore, a lower limit value in the size of the solar panel 22 may be set according to the transmittance of the dial 11 so that the power generation of the solar panel 22 is equal to or larger than the power consumption of the receiving device 30.

Even when the solar panel 22 does not have a disk shape, the lower limit value of the area of the light receiving unit may be set according to the transmittance of the dial 11 by setting the area of the light receiving unit to be 700 mm² or less.

### Advantageous Effect of Second Embodiment

According to the second embodiment as described above, the same advantageous effect can be obtained by the configurations that are the same as those of the first embodiment. In addition, the following advantageous effect can be further obtained.

According to the embodiments of the invention, as the solar panel 22 for charging the secondary battery 24, it is possible to use the solar panel in which the area of the light receiving unit is 700 mm² or less, for example, the solar panel in which the diameter is 30 mm or shorter if the solar panel 22 has a disk shape.

Therefore, the electronic timepiece 1 can be miniaturized and thus, can be commercialized as a wristwatch which can acquire the positioning information and correct the time to the local time. In addition, since the power consumption of the receiving device 30 is decreased, the longer duration of the secondary battery 24 can also be expected. Therefore, it is possible to ensure the required duration for the wristwatch which can acquire the positioning information and correct the time to the local time.

Since the transmittance of the dial 11 is restricted to 70% or less, it is possible to improve flexibility in the design of the dial 11, thereby enabling the design to be improved.

Since the transmittance of the dial 11 is set to be 50% or more, it is possible to set the solar panel 22 to have the diameter of 30 mm or shorter and to have the size which enables the power generation of 25 mW or more. Therefore, the solar panel 22 can be restricted to have the size which can be incorporated in the wristwatch.

### Third Embodiment

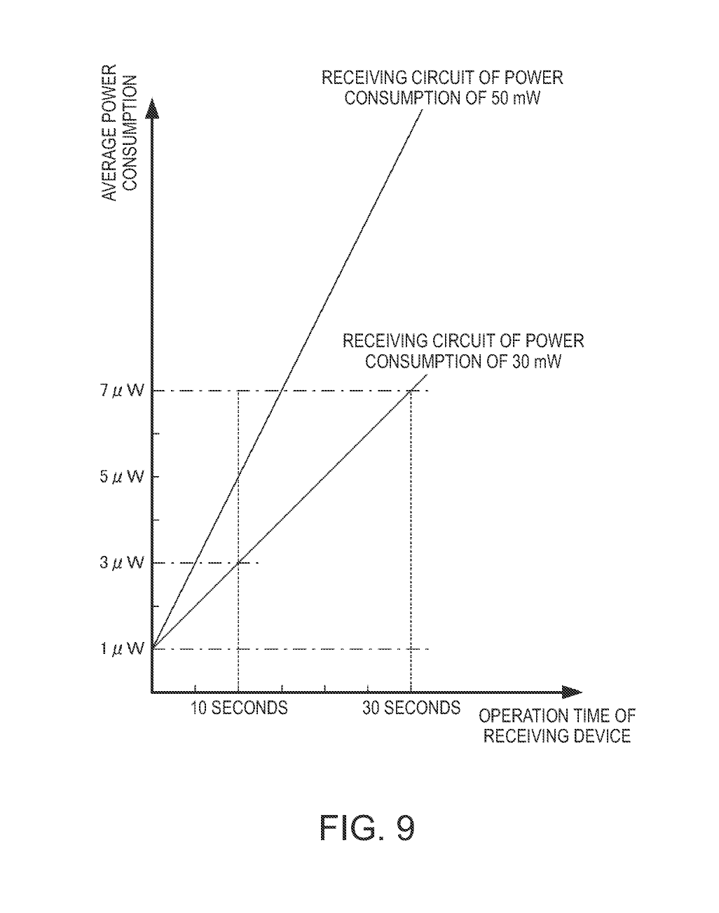

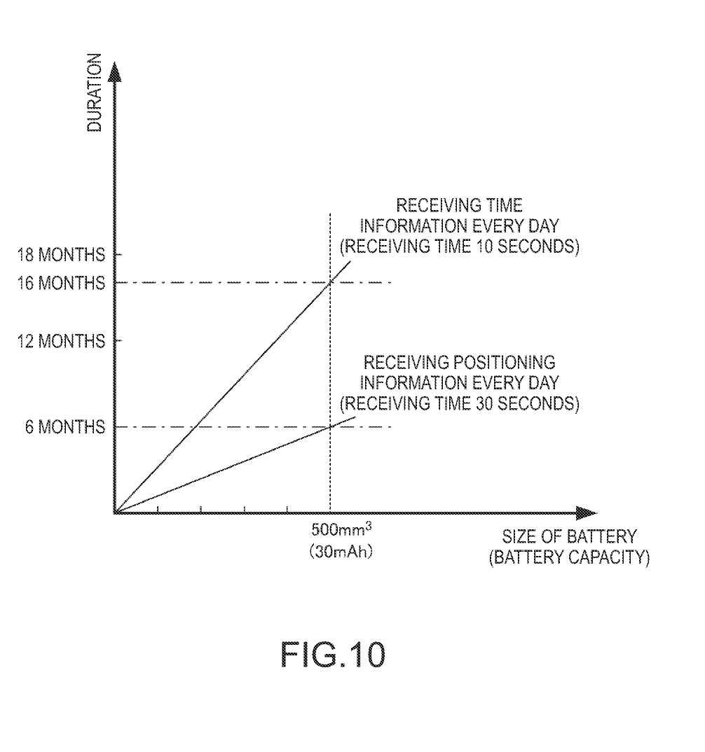

Next, a third embodiment of the invention will be described with reference to FIGS. 9 and 10. The third embodiment is made by setting the power consumption of the receiving device 30 and the size of the secondary battery 24. Except for these, the structure and the control process of the electronic timepiece 1 are similar to those in the first embodiment, and thus description thereof will be omitted.

In the present embodiment, when setting the size of the secondary battery 24, the duration and the battery capacity are considered. When considering the duration, it is necessary to understand the average power consumption. Therefore, the average power consumption in the electronic timepiece 1 will be described.

### Average Power Consumption

The average power consumption of the electronic timepiece 1 can be obtained by calculating the average power consumption for driving the electronic timepiece 1 which is required for operating the guiding hands 12 and 13 and the average power consumption of the receiving device 30.

As illustrated in FIG. 9, the average power consumption for driving the electronic timepiece 1 is the power required for operating the control device 40, the timing device 50, the drive mechanism 210 and the like, and is approximately 1 μW in general.

In addition, the power consumption of the receiving device 30 is mainly proportional to the operating time of the receiving device 30. The time for each receiving process in the timing mode for acquiring only the time information is approximately ten seconds. The time for each receiving process in the positioning mode for acquiring the positioning information is approximately 30 seconds. Therefore, the average power consumption is obtained in a case where the receiving process in the timing mode for ten seconds is performed once a day and in a case where the receiving process in the positioning mode for 30 seconds is performed once a day.

As a result, when using the receiving device 30 whose power consumption is 30 mW, the average power consumption during the receiving for ten seconds is approximately 2 and the average power consumption during the receiving for 30 seconds is approximately 6 μW.

In contrast, when using the receiving device whose power consumption is 50 mW, the average power consumption during the receiving for ten seconds is approximately 4 and the average power consumption during the receiving for 30 seconds is approximately 12 μW.

Therefore, as illustrated in FIG. 9, the average power consumption when the receiving process is performed by using the receiving device 30 of 30 mW for ten seconds every day is expressed by the average power consumption for driving the electronic timepiece 1: approximately 1 μW+the average power consumption of the receiving device 30: approximately 2 μW=approximately 3 μW.

In contrast, the average power consumption when the receiving process is performed by using the receiving device 30 of 30 mW for 30 seconds everyday is expressed by the average power consumption for driving the electronic timepiece 1: approximately 1 μW+the average power consumption of the receiving device 30: approximately 6 μW==approximately 7 μW.

In addition, the lithium ion secondary battery 24 has the high energy density as compared to the nickel-hydrogen battery. Accordingly, even when the size is small such as 600 mm³, the battery capacity can be adjusted to approximately 30 mAh. Therefore, as illustrated in FIG. 10, when the receiving process in the timing mode is performed once every day, the duration can be maintained for approximately 16 months. In addition, when the receiving process in the positioning mode is performed once every day, the duration can be maintained for approximately six months.

When using the receiving device of 50 mW, the average power consumption is increased a little less than twice. Accordingly, the duration is shortened to approximately half.

In addition, if the battery is generally deteriorated, the volume is increased. However, the size in this case is not considered.

### Advantageous Effect of Third Embodiment

According to the third embodiment as described above, the same advantageous effect can be obtained by the configurations that are the same as those of the first embodiment. In addition, the following advantageous effect can be further obtained.

The power consumption of the receiving device 30 is restricted to 30 mW or less per hour. Accordingly, it is possible to reduce the capacity or the size of the secondary battery 24. In particular, the lithium ion secondary battery whose energy density is high as compared to the nickel-hydrogen battery is used, thereby enabling the size (volume) to be miniaturized to 600 mm³ or less. That is, the size of the secondary battery 24 can be restricted to a size which is comparable to a button type or a coin type battery. Therefore, it is possible to drive the device requiring large power consumption, such as the receiving device 30. The electronic timepiece 1 can be commercialized for a wristwatch which can acquire the positioning information and correct the time to the local time.

In addition, even if the positioning mode for acquiring the positioning information is executed once a day, the secondary battery 24 is provided with the battery capacity which enables the duration to be maintained for six months or longer. Thus, it is possible to ensure an opportunity for charging of the secondary battery 24 by using the solar panel 22 in the meantime. Therefore, it is possible to continuously use the electronic timepiece 1 with a wristwatch size which can acquire the positioning information and correct the local time, thereby improving the convenience.

### Another Embodiment

The invention is not limited to the configuration of the respective embodiments. Various modifications can be made within the scope of the invention.

For the electronic timepiece 1, a configuration of another embodiment may also be applied to the respective embodiments. For example, an electronic timepiece in which the transmittance of the dial 11 is from 50% to 70% may be configured to include the solar panel 22 in which the power consumption of the receiving device 30 is 30 mW or less, the volume of the case is 30,000 mm³ or less, and the area of the light receiving unit is 700 mm² or less, and the secondary battery 24 whose volume is 600 mm³ or less.

That is, configurations of the respective embodiments can be set in appropriate combinations, since the configurations are made in order to realize the electronic timepiece having the size of the portable wristwatch which can receive the satellite signal of the GPS satellite 100 and acquire the positioning information.

In the respective embodiments, the positioning unit 420 also acquires the time information in addition to the positioning information, but may be set so as to acquire only the positioning information. In this case, the time zone setting unit 430 corrects only the time zone data 650 and the time zone correction unit 440 corrects only the time data for timepiece display 640, that is, only the display time of the first guiding hands 12.

In addition, in the embodiments, the GPS satellite has been described as an example of the positioning information satellite. However, in addition to the GPS satellite, the positioning information satellite according to the invention may include positioning information satellites which transmit the satellite signal containing the time information of stationary satellites in other Global Navigation Satellite Systems (GNSS) such as the Galileo (EU), the GLONASS (Russia) and the BeiDou (China) or SBAS, and quasi-zenith satellites.

The electronic timepiece according to the invention is not limited to the wristwatch. For example, the invention can be widely used in a device having a timepiece mechanism which has the device requiring large power consumption and is portably used, such as mobile phones and portable GPS receivers used when climbing or the like.

The entire disclosure of Japanese Patent Application No. 2013-46269, filed Mar. 8, 2013 and of Provisional Application No. 61/771,303, filed Mar. 1, 2013 is expressly incorporated by reference herein.

What is claimed is:

1. An electronic timepiece comprising:
a receiving unit that receives a satellite signal transmitted from a positioning information satellite;
a time display unit that displays a time;
a time correction unit that acquires time information from the satellite signal received by the receiving unit and corrects the time to be displayed on the time display unit; and
a case that accommodates the receiving unit, the time display unit and the time correction unit,
wherein power consumption of the receiving unit is 30 mW or less, and
wherein a volume of the case is 30,000 mm³ or less.

2. The electronic timepiece according to claim 1,
wherein the power consumption of the receiving unit is the maximum power consumption when searching for the positioning information satellite without using satellite orbit information of the positioning information satellite.

3. The electronic timepiece according to claim 1, further comprising:
a light-transmitting dial;
a solar panel that is arranged in a side opposite to a display surface of the dial; and
a secondary battery that is charged by power generated in the solar panel.

4. An electronic timepiece comprising:
a receiving unit that receives a satellite signal transmitted from a positioning information satellite;
a light-transmitting dial;
a solar panel that is arranged in a side opposite to a display surface of the dial; and
a secondary battery that is charged by power generated in the solar panel,
wherein power consumption of the receiving unit is 30 mW or less, and
wherein an area of a light receiving unit of the solar panel is 700 mm² or less.

5. An electronic timepiece comprising:
a receiving unit that receives a satellite signal transmitted from a positioning information satellite;
a light-transmitting dial;
a solar panel that is arranged in a side opposite to a display surface of the dial; and
a secondary battery that is charged by power generated in the solar panel,
wherein power consumption of the receiving unit is 30 mW or less, and
wherein a volume of the secondary battery is 600 mm³ or less.

6. The electronic timepiece according to claim 3,
wherein transmittance of the dial is from 50% to 70%.

7. The electronic timepiece according to claim 3,
wherein the receiving unit is configured to be capable of performing a receiving process in a positioning mode for acquiring positioning information and a receiving process in a timing mode for acquiring time information, and
wherein the secondary battery is a lithium ion secondary battery, and has a battery capacity whose duration is six months or longer in a fully charged state, when continuously driving the time display unit and performing the receiving process in the positioning mode once a day.
